(19) United States
(12) Patent Application Publication
(10) Pub. No.: US 2004/0033902 A1
(43) Pub. Date: Feb. 19, 2004

(54) Diphenyl ehter induction systemic resistance in plants

(76) Inventors: William J. Haddad, Danville, OH (US); Neil P. Badenhop, Pemberville, OH (US); Alan D. Stammen, St. Henry, OH (US); Theodore G. Bean, Franklin, PA (US); Terrence L. Graham, Hilliard, OH (US); Lian-mei Y. Graham, Hilliard, OH (US); Serena Landini, Columbus, OH (US)

Correspondence Address: SUGHRUE MION, PLLC, 2100 PENNSYLVANIA AVENUE, N.W., WASHINGTON, DC, 20037, US

(21) Appl. No.: 10/203,513

(22) PCT Filed: Feb. 12, 2001
(86) PCT No.: PCT/US01/03681

(51) Int. Cl. A01N 37/44; A01N 37/18; A01N 31/14

(52) U.S. Cl. 504/322; 504/334; 504/352

(57) ABSTRACT

The invention relates to a method for inducing systemic resistance in plants, thereby protecting plants against a broad range of plant pathogens and disease. The method of the invention comprises the application of a biologically active formulation, comprising a diphenyl ether, to a plant. In accordance with the invention, it has been observed that use of this formulation results in induced systemic resistance in a target plant. Also in accordance with the method of the invention, the formulation has been shown to trigger long-lasting, non-specific systemic resistance in the plant to a variety of pathogens and disease. Furthermore, the method of the invention results in an increase in the levels of plant isoflavones.

### CROSS-REFERENCE TO RELATED APPLICATIONS

This application claims benefit and priority from the following three applications: U.S. Provisional Application No. 60/181,933, filed Feb. 11, 2000; U.S. Provisional Application No. 60/181,707, filed Feb. 11, 2000; and U.S. Provisional Application No. 60/181,686, filed Feb. 11, 2000.

### FIELD OF THE INVENTION

The present invention relates to the field of inducing disease resistance in plants. More specifically, this invention relates to the induction of natural plant disease resistance, through the use of a formulation comprising a diphenyl ether. In certain embodiments, the present invention relates to a method for combating plant pathogens by inducing the productions of isoflavones in a plant.

### BACKGROUND OF THE INVENTION

Sclerotina sclerotiorum (white mold) damage in soybeans accounts for an estimated average annual loss of roughly 26 million dollars in the United States alone. Losses resulting from other crop diseases, such as sudden death syndrome (Fusarium species), brown stem rot, Phytophthora species, etc., add significantly to the 26 million dollar loss estimate resulting from white mold each year.

Attempts to control white mold and other diseases of soybeans have included the use of chemicals and biological control methods applied to the surface of the plant. These methods strive to block the growth and development of the disease-causing organism before it can enter the plant. While these methods can be effective, their duration is typically short term and their efficacy can depend on environmental conditions.

A second method of plant disease control is the use of disease-resistant cultivars. Typically, these plants are genetically engineered to produce compounds toxic to disease-causing organisms. However, the toxic compounds generally do not occur naturally in these plants. While this method of disease control can be very effective, and can be an improvement over the use of chemicals sprayed onto crops in both terms of time and safety, there has been resistance by the general public to the use of genetically engineered crops, both in the U.S. and abroad.

Recently, researchers have focused on a new method of plant disease control, through the augmentation of natural plant defenses. Plants innately resist pathogenic attacks in two general manners, through preformed barriers and induced mechanisms. The former include physical barriers and continuously-expressed defense proteins. These serve to stop initial pathogen entry and provide the means of minimizing deleterious effects if a barrier is breached. The latter are activated only upon challenge or breach of the preformed barriers. For example, localized infection by a pathogen results in the induction of physical changes at the site of infection (including cell wall lignification and papilla formation) (reviewed in Kessmann, H., Staub, T., Hofmann, C., Maetzke, T., Herzog, J., Ward, E., Uknes, S., and J. Ryals. 1994. Induction of systemic acquired resistance in plants by chemicals. Annual Review of Phytopathology 32: 439-459; Schneider, M., Schweizer, P., Meuwly, P., and J. P. Metraux. 1996. Systemic acquired resistance in plants. International Journal of Cytology 168: 303-340; Sticher, L., Mauch-Mani, B., and J. P. Metraux. 1997. Systemic acquired resistance. Annual Review ofPlant Pathology 35: 235-270). Additionally, signal transduction pathways are activated that lead to systemic resistance in uninfected parts of the plant (reviewed in Mauch-Mani, B., and J. P. Metraux. 1998. Salicylic acid and systemic acquired resistance to pathogen attack. Annals Botany 82: 535-540). Thus, the first infection conditions the plant to resist future insults, similar to the vaccination of humans and other animals. Importantly, though, this systemic resistance is broad spectrum, against widely different pathogens such as fungi, bacteria or viruses, and not merely the pathogen that caused the initial infection. While the conditioned state associated with systemic resistance is often transient, under some circumstances it can be sustained. Conditioning has also been termed “priming,” “activation,” “potentiation,” and “competency.”

At least two different signal transduction pathways appear to be involved in systemic resistance, although both similarly condition the plant to resist further pathogenic attacks. Systemic acquired resistance (SAR) is characterized by an accumulation of salicylic acid (SA) in plant tissues, and an increase in a class of proteins termed pathogenesis-related (PR) proteins (reviewed in Kessmann, H., Staub, T., Hofmann, C., Maetzke, T., Herzog, J., Ward, E., Uknes, S., and J. Ryals. 1994. Induction of systemic acquired resistance in plants by chemicals. Annual Review ofPhytopathology 32: 439-459; Hunt, M. D., and J. A. Ryals. 1996. Systemic acquired resistance signal transduction. Critical Review in Plant Science 15: 583-606; Ryals, J., Neuenschwander, U., Willits, M., Molina, A., Steiner, H. Y., and M. Hunt. 1996. Systemic acquired resistance. Plant Cell 8: 1809-1819; Schneider, M., Schweizer, P., Meuwly, P., and J. P. Metraux. 1996. Systemic acquired resistance in plants. International Journal of Cytology 168: 303-340; Yang, Y. O., Shah, J., and D. F. Klessig. 1997. Signal perception and transduction in defence responses. Genes and Development 11: 1621-1639). SA has been proposed to act by increasing cellular hydrogen peroxide concentrations (Chen, Z., Silva, H., and D. F. Klessig. 1993. Active oxygen species in the induction of plant systemic acquired resistance by salicylic acid. Science 262: 1883-1885), triggering lipid peroxidation (reviewed by Goodman, R. N., and A. J. Novacky. 1994. The hypersensitive reaction in plants to pathogens. St. Paul: APS Press), inducing alternative oxidase and thermogenesis (Raskin, I., and B. J. D. Meeuse. 1987. Salicylic acid: A natural inducer of heat production in Arum lilies. Science 237: 1601; Rhoads, D. M., and L. MacIntosh. 1992. Salicylic acid regulation of respiration in higher plants: alternative oxidase expression. Plant Cell 4: 1121-1139), and enhancing the subsequent response to elicitor treatment (reviewed in Mauch-Mani, B., and J. P. Metraux. 1998. Salicylic acid and systemic acquired resistance to pathogen attack. Annals Botany 82: 535-540). Through these mechanisms, and more directly, SA induces the expression of a number of defense related genes and proteins (Hunt, M. D., and J. A. Ryals. 1996. Systemic acquired resistance signal transduction. Critical Review in Plant Science 15: 583-606; Schneider, M., Schweizer, P., Meuwly, P., and J. P. Metraux. 1996. Systemic acquired resistance in plants. International Journal of Cytology 168: 303-340; Sticher, L., Mauch-Mani, B., and J. P. Metraux. 1997. Systemic acquired resistance. Annual Review of Plant Pathology 35: 235-270; Van Loon, L. C. 1997. Induced resistance in plants and the role of pathogenesis-related proteins. European Journal of plant Pathology 103: 753-765; Yang, Y. O., Shah, J., and D. F. Klessig. 1997. Signal perception and transduction in defence responses. Genes and Development 11: 1621-1639). While most reports agree that SA is an initial element of these signal transduction pathways, it is not clear if it is the primary systemic signal, or secondarily activated (Mauch-Mani, B., and J. P. Metraux. 1998. Salicylic acid and systemic acquired resistance to pathogen attack. Annals Botany 82: 535-540).

A second signal transduction pathway, termed induced systemic resistance (ISR), operates independently of the SAR pathway. An illustrative example is a study that demonstrated the plant growth-promoting rhizobacteria (PGPR) induced a systemic resistance-like phenomena without accumulation of SA accumulation or PR gene expression (Pieterse, C. M. J., Van Wees, S. C. M., Hoffland, E., Van Pelt, J. A., and L. C. Van Loon. 1996. Systemic resistance in Arabidopsis induced by biocontrol bacteria is independent of salicylic acid accumulation and pathogenesis-related gene expression. Plant Cell 8: 1225-1237). Additional studies have also shown that neither SA or PR protein levels increase upon induction of an ISR response. Thionins and the small, cysteine-rich plant defensins (PDFs) are found to accumulate upon induction of an ISR response, and are believed to be effectors of the response (Epple, P., Apel, K., and H. Bohlmann. 1995. An Arabidopsis thaliana thionin gene is inducible via a signal transduction pathway different from that for pathogenesis-related protein. Plant Physiology 109: 813-820; Penninckx, I. A. M. A., Eggermont, K., Terras, F. R. G., Thomma, B. P. H. J., DeSamblanx, G. W., Buchala, A., Metraux, J. P., Manners, J. M., and W. F. Broekaert. 1996. Pathogen-induced systemic activation of a plant defensin gene in Arabidopsis follows salicylic acid-independent pathway. Plant Cell 8: 2309-2323). These studies also suggested that methyl jasmonate may be a mediator of ISR. It was shown that the addition of methyl jasmonate to arabidopsis resulted in the induction of the thionin 2.1 gene, but that SA did not have the same effect (Epple, P., Apel, K., and H. Bohlmann. 1995. An Arabidopsis thaliana thionin gene is inducible via a signal transduction pathway different from that for pathogenesis-related protein. Plant Physiology 109: 813-820). Similarly, while methyl jasmonate, ethylene, paraquat and rose bengal were found to induce the accumulation of the antifungal plant defensin PDF1.2 in arabidopsis leaves, none of these chemicals had any effect on levels of PR-1 mRNA (Penninckx, I. A. M. A., Eggermont, K., Terras, F. R. G., Thomma, B. P. H. J., DeSamblanx, G. W., Buchala, A., Metraux, J. P., Manners, J. M., and W. F. Broekaert. 1996. Pathogen-induced systemic activation of a plant defensin gene in Arabidopsis follows salicylic acid-independent pathway. Plant Cell 8: 2309-2323). In contrast, SA induced the accumulation of PR-1 mRNA but not the defensin or its mRNA (Penninckx, I. A. M. A., Eggermont, K., Terras, F. R. G., Thomma, B. P. H. J., DeSamblanx, G. W., Buchala, A., Metraux, J. P., Manners, J. M., and W. F. Broekaert. 1996. Pathogen-induced systemic activation of a plant defensin gene in Arabidopsis follows salicylic acid-independent pathway. Plant Cell 8: 2309-2323). In arabidopsis plants over-expressing the nahG gene (characterized by very low levels of SA) (Delaney, T. P., Uknes, S., Vemooij, B., Friedrich, L., Weymann, K., Negrotto, D., Gaffney, T., Gutrella, M., Kessmann, H., Ward, E., and J. Ryals. 1994. A central role of salicylic acid in plant disease resistance. Science 266: 1247-1250), and in the npr1 mutant (no detectable PR-1 protein expression) (Cao, H., Bowling, S., Gordon, A., and X. Dong. 1994. Characterization of Arabidopsis mutant that is non-responsive to inducers of systemic acquired resistance. Plant Cell 6: 1583-1592), induction with an avirulent fungus led to accumulation of defensin, demonstrating that plants with defective SAR pathways maintain functional ISR pathways. Moreover, two arabidopsis mutants demonstrated that an inability to respond to ISR inducers results in decreased expression of ISR-associated proteins, but not SAR-associated proteins. While coii, which does not respond to methyl jasmonate (Feys, B. J. F., Benedetti, C. E., Penfold, C. N., and J. G. Turner. 1994. Arabidopsis mutants selected for resistance to the phytotoxin coronatine are male sterile, insensitive to methyl jasmonate, and resistant to a bacterial pathogen. Plant Cell 6: 751-759), and ein2, which does not respond to ethylene (Guzman, P., and J. Ecker. 1990. Exploiting the triple response of Arabidopsis to identify ethylene-related mutants. Plant Cell 2: 513-523), both produce PR-1, both also show a highly reduced ability to accumulate the PDF1.2 plant defensin after fungal induction treatment. These studies, and others, demonstrate that the ISR and SAR responses are unique and different.

Not all plants possess both of these signal transduction pathways. For example, soybeans are believed to lack the elements required for an SAR response. While treatment of soybean cotyledon tissues with either methyl jasmonate or 1-aminocyclopropanecarboxylic acid gives rise to protection of cells distal from the point of application (Park, D.-S. 1998. Proximal cell competency and distal cell potentiation in soybean resistance. Ph.D. Thesis. The Ohio State University), SA does not induce any detectable changes in soybean defense pathways.

In addition to this ISR pathway, it has been suggested that soybeans may have a response that may “substitute” for the SA response seen in most plants. This substitute response is characterized by a high accumulation isoflavones including daidzein, and conjugates of the isoflavone genistein (present in the apoplast of soybean seedling tissues as a malonyl glucosyl conjugate (MGC), likely released by a highly isoflavone specific apoplastic β-glucosidae (Hsieh, M.-C. 1997. Purification and characterization of an isoflavone specific β-glucosidase from soybean. Ph.D. Thesis, The Ohio State University)) Genistein is then thought to act in a manner somewhat similar to SA in activating the defense potential of soybean cells (T. L. Graham and M. Y. Graham 2000. Defense Potentiation and Elicitation Competency: Redox Conditioning Effects of Salicylic Acid and Genistein, pp 181-219, Plant-Microbe Interactions, G. Stacey and N. Keen, eds).

Isoflavones are phytoestrogens that are naturally produced in plants including those belonging to the family Leguminosae, particularly in plants belonging to the subfamily the Papilionoidease which includes soybeans. Recent studies have shown that plants which do not belong to the family Leguminosae can be genetically engineered to produce isoflavones. For example, Arabidopsis thaliana has been transformed with a single enzyme which allows it to produce genistein (Yu, Oliver; Jung, Woosuk; Shi, June; Croes, Robert A.; Fader, Gary M.; McGonigle, Brian; Odell, Joan T. 2000. Production of the isoflavones genistein and daidzein in non-legume dicot and monocot tissues. Plant Physiology 124:781-793).

Isoflavones exist in an inactive form in plants, attached to a sugar molecule such as glucose. The free isoflavone form, which is known as an “aglycone” is released upon wounding or infection by a pathogen. Once released, the aglycones play multiple roles in the establishment of the capacity of the cell to mount an effective defense response. For example, the isoflavone daidzein is a precursor of the plant antibiotic “phytoalexin” glyceollin, and the isoflavone genistein aids in the priming of the soybean's capacity (competency) to recognize pathogen-derived “elicitors” that trigger glyceollin production. Furthermore, genistein itself has some antibiotic activity. Thus, the simple release of these two aglycones enhances three critical and complementary aspects of plant defense. Application of methyl jasmonate greatly potentiates this response (Graham, T. L., and M. Y. Graham. 1996. Signaling in soybean phenylpropanoid response: dissection of primary, secondary and conditioning effects of light, wounding and elicitor treatments. Plant Physiology 110: 1123-1133). The accumulation of isoflavone conjugates thus “loads” the capacity of the soybean to respond to a pathogen. The formation of glyceollin from released daidzein “taps” into this pool of isoflavones.

Unfortunately, levels of the isoflavones in soybean are not always adequate to effectively launch these resistance responses. Some tissues (for instance, mature leaves) have relatively low levels of isoflavones and the isoflavone content of tissues are decreased under certain environmental conditions such as low light (cloudy weather). As a result of this lack of adequate isoflavone levels, the plants become less resistant to attack by phytopathogens.

Methods of “priming” a plant to resist attack by phytopathogens, both through the triggering of ISR and inducing an increase in the level of plant isoflavones, would serve to increase the choices available to plant growers, from farmers to backyard gardeners, for combating plant pathogens. The present invention presents an environmentally safe, effective and convenient formulation and method for triggering ISR and increasing the levels of plant isoflavones.

### SUMMARY OF THE INVENTION

The present invention relates to a method of triggering induced systemic resistance in a plant comprising applying an effective amount of a biologically active formulation comprising a diphenyl ether to the surface of at least a part of the plant, triggering activation of induced systemic resistance in the plant, thereby inducing systemic resistance to at least one pathogen or disease.

In another embodiment, the present invention relates to a method of increasing plant yield comprising, applying an effective amount of a biologically active formulation comprising a diphenyl ether to the surface of at least a part of the plant, triggering activation of induced systemic resistance in the plant, and maintaining or increasing the general health of the plant, thereby increasing crop yield.

In yet another embodiment of the invention, the present invention provides a method for increasing the levels of isoflavones in plants comprising, applying an effective amount of a biologically active formulation comprising a diphenyl ether to the surface of at least a part of the plant, triggering release or production of isoflavones, thereby increasing the levels of isoflavones in plants. Advantageously, the present method also enhances the glyceollin elicitation competency of the treated plant.

The active diphenyl ether of the present invention preferably has the structure:

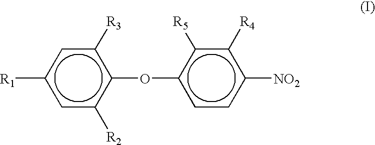

wherein R₁ is a hydrogen, fluorine, or chlorine atom, or a trifluoromethyl group; R₂, R₃ and R₅ are independently a hydrogen, fluorine, or chlorine atom; R4 is a hydrogen atom, NR₆, NR₆R₆, OR₆, COOR₆, COOCHR₆CO₂R₆, CONHSO₂R₆, or a cyclic ether, wherein R₆ is a hydrogen atom, a branched alkyl group of 1 to 4 carbon atoms or a linear alkyl group of 1 to 4 carbon atoms.

The active diphenyl ether of the present invention also preferably has the structure:

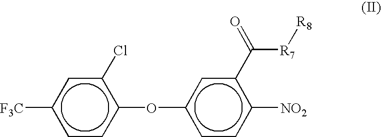

wherein R₇ is an oxygen or nitrogen atom; and R₈ is a hydrogen atom, CH₃, an aliphatic chain comprising 2 to 5 carbon atoms, or HSO₂CH₃.

In each of the above embodiments, the diphenyl ether is more preferably acifluorfen, aclonifen, bifenox, chlomethoxyfen, chlomitrofen, fluorodifen, fluoroglycofen, fluoronitrofen, fomesafen, furyloxyfen, halosafen, lactofen, nitrofen, nitrofluorfen or oxyfluorfen. Most preferably, the diphenyl ether is lactofen.

In other preferred embodiments, the biologically active formulation further comprises one or more adjuvants selected from crop oil concentrates, surfactants, fertilizers, emulsifiers, dispersing agents, foaming activators, foam suppressants, and correctives. In a more preferred embodiment, the one or more adjuvants in the biologically active formulation are a crop oil concentrate, a surfactant and a fertilizer.

### BRIEF DESCRIPTION OF THE DRAWINGS

FIG. 1 depicts a working model for the establishment of elicitation competency in soybeans via release of isoflavone conjugates. Details of this model can be found in: T. L. Graham and M. Y. Graham. 1999. Role of hypersensitive cell death in conditioning elicitation competency and defense potentiation. Physiol. MoL Plant Pathol. 55:13-20.

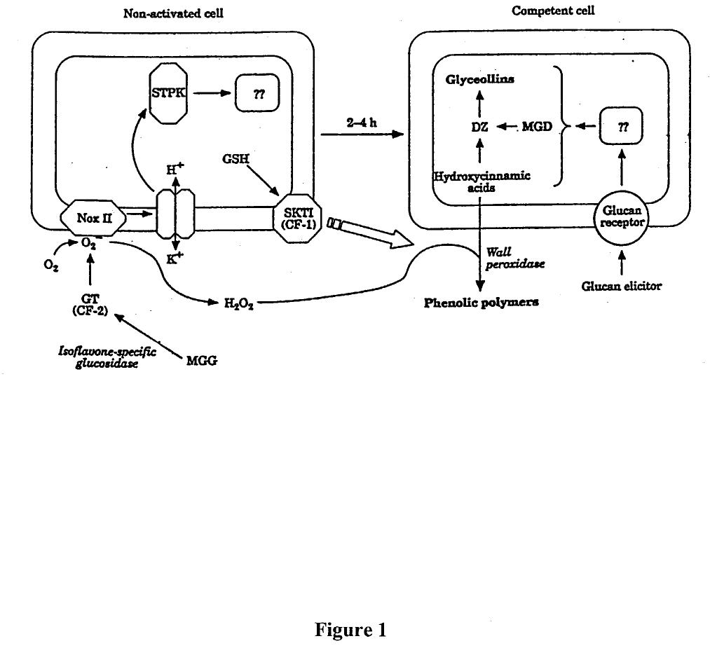

### DETAILED DESCRIPTION OF THE INVENTION

The biologically active formulation of the present invention has unexpectedly been found to trigger ISR and increase the levels of isoflavones in plants. In one embodiment of the invention, treatment of plants with the biologically active formulation leads to decreased incidence of pathogen or disease-caused plant damage, exhibiting the beneficial effects of ISR. In another embodiment of the invention, plants treated with the biologically active formulation are more robust and produce a higher yield upon harvest, suggesting ISR is broad-based and non-specific, allowing a plant to grow unimpeded throughout the growing season. In a third embodiment of the invention, plants treated with the biologically active formulation had a higher level of isoflavones than found in non-treated plants. This increase was found in all plant parts tested, including seeds, cotyledons, leaves and stems.

In each of these embodiments, the biologically active compound is a diphenyl ether, which is preferably encompassed by formula (I) and/or formula (II).

In the present invention, the term “induced systemic resistance” or “ISR” refers to an inducible, plant-wide resistance to the growth and pathogenic effects of pathogenic organisms and disease. Such resistance may be total or somewhat less than total. Furthermore, such resistance may be induced in a therapeutic or prophylactic manner. ISR is also used interchangeably with the terms “immunity,” “resistance,” “disease resistance,” and “induced disease resistance.”

As used herein the term “plant” encompasses all forms and organs of a monocotyledonous or dicotyledonous plant, including but not limited to the seed, the seedling, and mature plant.

1. Production of Biologically Active Formulations Comprising a Diphenyl Ether

In the present invention, the biologically active formulation is comprised of at least one diphenyl ether compound (i.e., a compound having the core structure of

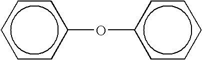

with desired substitutions on one or both of the phenyl rings) as the active ingredient. As would be understood by one of ordinary skill in the art, the term “diphenyl ether” as used herein encompasses any active form of the compound, including acid and salt forms, metabolites, racemic mixtures of stereo- or optical isomers, purified isomers, etc.

Preferably, for triggering induced systemic resistance in a plant and/or increasing plant yield, the diphenyl ether has the structure shown as (I) above. Non-limiting examples of diphenyl ethers suitable for use in the present invention include acifluorfen, aclonifen, bifenox, chlomethoxyfen, chlomitrofen, fluorodifen, fluoroglycofen, fluoronitrofen, fomesafen, furyloxyfen, halosafen, lactofen, nitrofen, nitrofluorfen and oxyfluorfen.

In another embodiment, the method comprises administering to the plant an agricultural chemical composition comprising a phytologically acceptable carrier or diluent and an effective amount of a diphenyl ether, preferably having the structure shown as (II) above. The structures of several preferred diphenyl ethers which are useful in this method and which have been tested are shown below:

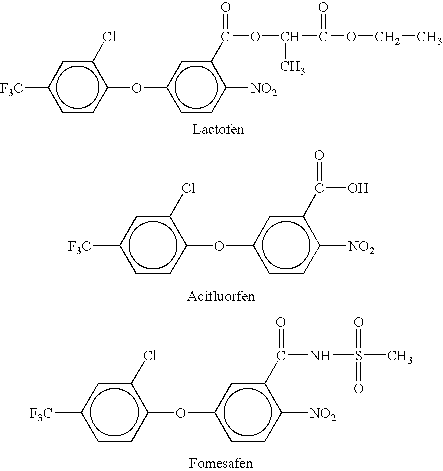

In yet another embodiment, the diphenyl ether has a structure represented by formula

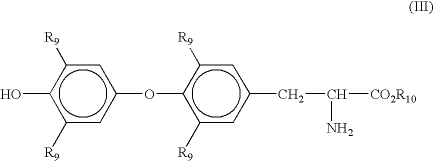

wherein R₉ is H, Cl, I, Br or CF₃; and R₁₀ is a branched aliphatic chain comprising 1-5 carbon atoms. Compounds of formulas (II) and (III) are particularly useful in the method of increasing the levels of isoflavones in plants.

The biologically active formulation of the present invention is produced by mixing the active ingredient into water. One or a mixture of diphenyl ether compounds can be used as the active ingredient. Although one of ordinary skill in the art will understand that various volumes of the biologically active formulation may be prepared, depending on the size of the area to be treated, 15 gallons is a useful volume. As such, the biologically active formulation of the invention can be produced in preferred embodiments by mixing between about 0.0050 and 0.50 pounds of the active ingredient into 15 gallons of water, more preferably, between about 0.050 and 0.125 pounds, most preferably, about 0.1 pounds. Of course, these limits are not absolute, and the outer boundaries could be readily determined by one of ordinary skill in the art.

A preferred diphenyl ether used as the active ingredient in the present invention is lactofen (C₁₉H₁₅ClF₃NO₇) (2-ethoxy-1-ethyl-2-oxoethyl 5-[2-chloro-4-(trifluoromethyl)phenoxy]-2-nitrobenzoate). A biologically active formulation comprised of lactofen as the active ingredient is typically produced by mixing lactofen into water. Preferably, between about 0.0050 and 0.50 pounds of lactofen is mixed into 15 gallons of water, more preferably, between about 0.050 and 0.125 pounds, most preferably, about 0.1 pounds.

An exemplary form of commercially-available lactofen is the herbicide Cobrag, produced by Valent U.S.A. Corporation. Cobra® has been approved for use as a selective, broad spectrum herbicide for pre-emergence and post-emergence control of susceptible broadleaf weeds (EPA Reg. No. 59639-34). Cobra® is commercially available in a concentrated form comprised of 23.2% lactofen by weight and 76.8% other ingredients, and is sold as a liquid containing 2 pounds of lactofen per gallon. A biologically active formulation comprised of Cobra®, containing lactofen as the active ingredient, is produced by mixing Cobra® into water. As used in the Examples below, and as typically used in the field, preferably between about 0.25 and 50 fluid ounces of Cobra® is mixed into 15 gallons of water, more preferably, between about 2.5 and 10 fluid ounces, most preferably, about 6 fluid ounces.

Other useful forms of lactofen include the herbicide Stellar®, also produced by Valent U.S.A. Corporation (EPA Reg. No. 59639-92). Stellar is comprised of 26.6% lactofen by weight, 7.6% flumiclorac pentyl ester, and 65.8% other ingredients. Flumiclorac pentyl ester is the active ingredient in Resource® herbicide.

While the biologically active formulation of the present invention may be comprised of a diphenyl ether alone, it is preferred that the formulation also includes one or more adjuvants. Useful adjuvants include, without limitation, crop oil concentrates, surfactants, fertilizers, emulsifiers, dispersing agents, foaming activators, foam suppressants, and correctives. Adjuvants generally facilitate the entry of the diphenyl ether active ingredient through plant cell walls. A phytologically acceptable carrier is a physiologically acceptable diluent or adjuvant. The term “phytologically acceptable” means a non-toxic material that does not interfere with the effectiveness of the diphenyl ether. The usefulness of a particular adjuvant or carrier depends on, among other factors, the species of the plant being treated with the formulation of the invention, the plant's growth stage and the related environmental conditions, the route of administration and the particular compound or combination of compounds in the composition. In a more preferred embodiment, the one or more adjuvants in the biologically active formulation are a crop oil concentrate, a surfactant and a fertilizer. Preparation of such formulations is within the level of skill in the art.

A biologically active formulation comprised of a diphenyl ether, a crop oil concentrate, a surfactant and a fertilizer, is produced by mixing each of the compounds into water in the following order: fertilizer, diphenyl ether, crop oil concentrate, surfactant. Although one of ordinary skill in the art will understand that various volumes of the biologically active formulation may be prepared, depending on the size of the area to be treated, 15 gallons is a useful volume. As such, this embodiment of the biologically active formulation can be produced by mixing between about 0.1 and 10 pounds of ammonium sulfate into 15 gallons of water, more preferably, between about 1 and 4 pounds, most preferably, about 2 pounds. Exemplary fertilizers found to be useful in formulations of this embodiment of the invention include ammonium sulfate. A second exemplary fertilizer found to be useful in formulations of this invention is urea ammonium nitrate. In an embodiment utilizing urea ammonium nitrate, preferably, between about 1 and 200 fluid ounces of urea ammonium nitrate are mixed into 15 gallons of water, more preferably, between about 25 and 100 fluid ounces, most preferably about 50 fluid ounces. Preferably, between about 0.0050 and 0.50 pounds of the diphenyl ether active ingredient are next mixed into the formulation, more preferably, between about 0.050 and 0.125 pounds, most preferably, about 0.1 pounds. As noted above, one or a mixture of diphenyl ether compounds can be used as the active ingredient. Then, preferably between about 1 and 100 fluid ounces of a crop oil concentrate are next mixed into the formulation, more preferably, between about 5 and 25 fluid ounces, most preferably, about 10 fluid ounces. Crop oil concentrates are generally comprised of from 65-96% by weight of a hydrocarbon oil or solvent with the balance being a surfactant. The hydrocarbons may be petroleum or vegetable based. Exemplary crop oil concentrates found to be useful in the formulations of this invention include methylated seed oil, Dyne-Amic® (Helena Chemical Co.) and Herbimax® (Loveland Industries Inc.). A preferred amount of a non-ionic surfactant, generally in the range of about 0.1 to 25 fluid ounces, are finally mixed into the formulation, more preferably between about 2 and 10 fluid ounces, most preferably about 5 fluid ounces. Surfactants are also available from a variety of commercial sources. Useful forms include anionic, cationic, nonionic and ampholytic surfactants. Exemplary surfactants found to be useful in the formulations of this invention include Kinetic® (Helena Chemical Co.) and Induce® (Helena Chemical Co.).

In a further embodiment of the invention, the biologically active formulation may also contain one or more other active chemicals, such as herbicides, insecticides, fungicides, bacteriocides, and plant growth regulators. As used in the present invention, the term “other active chemicals” refers to those chemicals having activities other than the ability to trigger ISR in plants, such as insecticidal, herbicidal, fungicidal, bacteriocidal, etc. In a preferred embodiment, the one or more other active chemicals in the biologically active formulation is a herbicide. Non-limiting examples of acceptable herbicides include 2,4-DB, Assure®/Assure II, Basagran®, Classic®, Firstrate®, Fusilade® DX, Option®, Passport®, Pinnacle®, Pursuit®, Pursuit Plus®, Reliance™ STS®, Roundup Ultra®, Select® 2 EC, Scepter®, and Synchrony™ STS®. A biologically active formulation containing a herbicide is produced by mixing the herbicide into water, followed by a fertilizer (if any), the diphenyl ether active ingredient, a crop oil concentrate (if any), and a surfactant (if any), in that order. For a 15 gallon biologically active formulation, the mixture can be produced by mixing between about 0.005 and 10 pounds of the herbicide active ingredient into 15 gallons of water, more preferably between about 0.5 and 5 pounds, most preferably about 1 pound. The remaining ingredients are then mixed into the formulation as directed above. An exemplary herbicide found to be useful in the formulation of this invention is Roundup Ultra® (Monsanto Corp.), a post-emergence, non-selective systemic herbicide.

One of ordinary skill in the art will understand that other inert ingredients may be included in all embodiments of the biologically active formulation of the invention to provide a more satisfactory formulation, provided the inert ingredients do not detract from the effect of the essential components of the invention. The composition may further contain other agents which either enhance the activity of the diphenyl ether or complement its activity. Such additional factors and/or agents may be included in the composition to produce a synergistic effect with the diphenyl ether, or to minimize side effects. The composition may further comprise fillers, salts, buffers, stabilizers, solubilizers, and other materials well known in the art.

2. Application of Biologically Active Formulations to Plants

One of ordinary skill in the art will understand that the methods of the invention may be practiced by applying a formulation comprising a diphenyl ether alone, although it is preferred that at least one adjuvant is present in the formulation. The methods of the invention may be practiced by applying a formulation comprising a diphenyl ether, one or more adjuvants, with or without other active chemicals, and with or without other inert ingredients. Furthermore, it will be understood that the diphenyl ether, one or more adjuvants, other active chemicals, and other inert ingredients may be applied concurrently or sequentially (in any desired sequence) so long as each component will perform as intended in accordance with the invention. If applied sequentially, the individual components may be applied over a short or long time frame.

The biologically active formulation of this invention may be applied to seed, to roots, or to leaves and stems. The composition may be administered to seed by coating the seed with a powdered composition, which may include a “sticker”, to the soil, or to seed and/or the root zone either as a liquid or in a granulated form. The composition may be applied to the surface of the plant in a single application until the leaves of the plant are partially wetted, fully wetted or until runoff. The treatment of the plant may also involve adding the composition to the water supply of the plants, or in the case of plants grown by tissue culture, to the culture media. The formulation may be applied at any time of day or night with good resistance resulting, but preferentially on actively growing plants and at least 30 minutes before a predicted rainfall. The application can be repeated as often as considered useful, with one or more “booster” applications applied to bolster resistance should the previously induced resistance begin to fade, as evidenced by the onset of disease symptoms. Thus, the formulation may be considered “prophylactic” as well as “therapeutic.” In a preferred embodiment, the formulation is applied by spraying the formulation onto the plants. Non-limiting examples of means for spraying the formulation onto plants include a tractor boom sprayer, a hand held aerosol sprayer, airblast sprayer, and helicopter or fixed-wing aircraft boom sprayer. Preferably, the sprayer is calibrated to deliver the formulation at between about 1 and 100 gallons per acre, more preferably between about 3 and 50 gallons per acre, most preferably about 15 gallons per acre.

It will be apparent to one of ordinary skill in the art that the “effective amount” of the diphenyl ether compound required to trigger ISR in a plant will be largely variable, depending on many factors, including the species of plant and its growth stage, row and plant spacing, environmental conditions, weather, etc. In general however, it has been determined that a biologically active formulation comprised of a diphenyl ether, applied in amounts generally between about 0.001 and 10 pounds active ingredient per acre, adequately triggers ISR in plants to which it is applied. More preferably, between about 0.01 and 1 pounds active ingredient per acre is used to trigger ISR. Most preferably, about 0.05 to about 0.25 pounds active ingredient per acre is used to trigger ISR.

An effective amount of diphenyl ether for the induction of increased levels of isoflavones is an amount sufficient to increase the levels of an isoflavone, such as genistein and daidzein, in the treated plant above levels found in control untreated plants. Such amounts can be determined by routine testing such as measurement by high performance liquid chromatography as noted below. The effective amount can be achieved by one application of the composition. Alternatively, the effective amount is achieved by multiple applications of the composition to the plant. The amount of the diphenyl ether in the composition will depend upon the particular compound or mixture of compounds being employed, the plant tissue being treated, and the ability of the plant to take up the composition. For instance, young plant leaves take up most compositions more readily than older leaves. It is contemplated that the various compositions used to practice the method of the present invention should contain from about 200 micromolar to 2 millimolar per dose of the diphenyl ether.

In a preferred embodiment, the biologically active formulation applied to plants is comprised of a fertilizer, a diphenyl ether, a crop oil concentrate, and a surfactant. Preferably, the fertilizer is added to the formulation in an amount so as to be applied at a rate of between about 0.1 and 10 pounds per acre, more preferably between about 1 and 4 pounds per acre, most preferably about 2 pounds per acre. Preferably, the diphenyl ether of this preferred formulation is applied within the range discussed above. Preferably, the crop oil concentrate of the formulation is applied at a rate of between about 1 and 100 fluid ounces per acre, more preferably between about 5 and 25 fluid ounces per acre, most preferably about 10 fluid ounces per acre. Preferably, the surfactant of the formulation is applied at a rate of between about 0.1 and 25 fluid ounces per acre, more preferably between about 2 and 10 fluid ounces per acre, most preferably about 5 fluid ounces per acre. Again, it is anticipated that within these general guidelines, one of ordinary skill in the art would be readily able to select an appropriate formulation and application volume per acre, to achieve the objects and advantages of the present invention.

The ISR and/or increased levels of isoflavones triggered by the biologically active formulation of the invention results in plant resistance to pathogens and disease, and depending on the application method and conditions of application, the present methods will provide specific and/or broad spectrum disease control including prevention of fungal infections and also infection by bacterial, viral and nematode pathogens. Non-limiting examples of plant pathogens include insects (e.g., diptera, hymenoptera, coleoptera, lepidoptera, orthoptera, hemiptera, and homoptera), bacteria (in soybeans, for example, Pseudomonas syringae pv. glycinea and Xanthomonas campestris pv. phaseoli), viruses (in soybeans, for example, Bean Pod Mottle Virus, Cowpea Chlorotic Mottle Virus, Peanut Mottle Virus, Soybean Dwarf Virus, Soybean Mosaic Virus, Tobacco Ringspot Virus, Tobacco Streak Virus, Bean Yellow Mosaic Virus, Black Gram Mottle Virus, Cowpea Mild Mottle Virus, Cowpea Severe Mosaic Virus, Indonesian Soybean Dwarf Virus, Mung Bean Yellow Mosaic Virus, Peanut Stripe Virus, Soybean Chlorotic Mottle Virus, Soybean Crinkle Leaf Virus, Soybean Yellow Vein Virus, and Tobacco Mosaic Virus), fungi (in soybeans, for example, Cercospora sojina, Chaetomium cupreum, Colletotrichum truncatum, Diaporthe-Phomopsis Complex, Fusarium spp., Macrophomina phaseolina, Peronospora manschurica), and nematodes (in soybeans, for example, Soybean Cyst Nematode, Lance Nematodes, Lesion Nematodes, Reniform Nematode, Root-Knot Nematodes, and Sting Nematodes).

Non-limiting examples of plant diseases include 1) infectious diseases such as a) bacterial diseases (in soybeans, for example, Bacterial Blight, Bacterial Pustule, Bacterial Tan Spot, Wildfire, Bacterial Wilts, and Crown Gall), b) mycoplasmalike diseases (in soybeans, for example, Machismo, Bud Proliferation, Witches' Broom and Phyllody), c) fungal diseases of foliage, upper stems, pods, and seeds (in soybeans, for example, Alternaria Leaf Spot and Pod Necrosis, Anthracnose, Brown Spot, Cercospora Blight and Leaf Spot, Choanephora Leaf Blight, Downy Mildew, Frogeye Leaf Spot, Phyllosticta Leaf Spot, Powdery Mildew, Red Leaf Blotch, Rhizoctonia Aerial Blight, Rust, Scab, and Target Spot), d) fungal diseases of roots and lower stems (in soybeans, for example, Brown Stem Rot, Charcoal Rot, Fusarium Blight or Wilt, Root Rot, and Pod and Collar Rot, Phytophthora Stem Rot, Pod and Stem Blight and Phomopsis Seed Decay, Stem Canker, Pythium Rot, Red Crown Rot, Rhizoctonia Diseases, Sclerotinia Stem Rot, Sclerotium Blight, and Thielaviopsis Root Rot), e) viral disease (in soybeans, for example, bud blight, soybean mosaic, f) nematode diseases, g) seedbome bacteria and bacterial diseases of seeds (in soybeans, for example, Bacillus Seed Decay), h) seedbome fungi and fungal diseases of seeds (in soybeans, for example, Alternaria Pod and Seed Decay, Purple Seed Stain, Yeast Spot (Nematospora Spot), and Phomopsis Seed Decay), i) seedborne viruses; 2) diseases of unknown or uncertain cause (in soybeans, for example, Foliage Blight, Sudden Death Syndrome, and Yellow Leaf Spot); and 3) noninfectious or stress diseases (e.g., crusting and compaction, frost, hail, heat canker, lightning, sunburn, water stress, mineral deficiencies and toxicities, herbicide damage, insecticide damage, and air pollutants). Specific examples of administration would be for control of phytophthora root rot, sclerotinia white mold, brown stem rot and the soybean cyst nematode.

The ISR and/or increased levels of isoflavones triggered by the biologically active formulation of the invention has also been unexpectedly discovered to result in increased plant yields. In the present invention, the term “yield” refers to the useable plant product produced by the plant. In the present invention, plant yield is expressed as a value of dry weight in bushels per acre. When properly applied, the biologically active formulation of the invention can increase plant yield a minimum of about 0.5%, more preferably the increase is at least 5%, and most preferably, the increase is 30% or more, in comparison to the same plant grown under the same environmental conditions but without application of the active formulation of the invention. Even an increase in yield of 0.5% is an economically significant increase on a large, multi-acre farm. The same general guidelines for preparing biologically active formulations, and effective application rates to the plants, as set forth above, can be used to achieve this objective of the invention.

Plants capable of producing isoflavones include those plants that naturally produce isoflavones, such as plants in the family Leguminosae, subfamily Papilionoidease, as well as plants that have been genetically engineered to produce isoflavones.

In a further embodiment, the invention provides plants, especially crops, which have ISR. In a particularly useful aspect, the ISR is long lasting, often persisting until harvest time. If desired, a booster immunization can be applied at a later date after initial application of the formulation. The booster immunization may be applied if the initial resistance appears to be fading, that is, if the plants develop disease symptoms.

The method of the invention may be used to trigger ISR and/or increased levels of isoflavones in a great variety of plants, including vegetable and fruit crops, legumes, cereals, fruit trees, berries, forestry trees, ornamental plants, and other plants such as coffee and cotton. In a preferred embodiment of this invention, the method is used to trigger ISR and/or increased levels of isoflavones in legume plants such as soybeans, lima beans, pinto beans, green beans, peas, chickpeas, peanuts and mung beans.

The scope of this invention also applies to crops where ISR and/or increased levels of isoflavones are important. By applying a biologically active formulation comprising a diphenyl ether, the plants are rendered systemically competent to attacks from a wide range of pathogens and disease. This has various advantages over current methods of plant protection. These advantages include, but are not limited to: 1) broad spectrum control because ISR is less specific than most fungicides or bactericides, and 2) less frequent applications because ISR is more systemic and longer lasting than the protection most fungicides or bactericides provide.

It has been observed that the triggering of ISR and/or increased levels of isoflavones in accordance with the invention results in a systemic resistance that lasts at least several weeks (for instance, 4 to 6 weeks) and may last throughout the growing season and/or throughout the life of the plant. Alternatively, treatment with the method of the invention may result in something less than total resistance to disease. Such reduced resistance may still provide the plant with resistance to pathogens and diseases. Reduced resistance may not be a total resistance, but will reduce the growth of pathogenic organisms adequately and will reduce the pathologic effects of those organisms.

It is an unexpected advantage of the invention that the resistance induced by the method of the invention is non-specific. Plants treated in accordance with the method of the invention have been found to be resistant to pathogen growth and disease from a broad range of pathogens, including bacteria, fungi, and viruses. This non-specificity is in contrast to the specificity of resistant cultivars and to other chemical methods of disease control. Because of this non-specificity, ISR can protect plants from pathogens against which no other treatments are yet known.

3. Methods of Assessing the Effect of the Diphenyl Ethers on Production of Isoflavones and the Activation of Defense Elicitors in the Soybean System.

The soybean cotyledon assay is the standard assay for assessing the activity of defense elicitors in the soybean system. There are two adaptations of this assay which can be used to determine the effective concentration of the nuclear receptor ligands.

Cut Cotyledon Assay

The cut cotyledon assay is used to investigate both the ability of a compound (effector) to activate basal elicitation competency in plants, and to evaluate the ability of a secondary compound (elicitor) to enhance glyceollin elicitation competency in plants in which the isoflavone pools were “loaded” by the action of the effector.

The level of isoflavones in the cotyledon tissues are measured after the addition of different diphenyl ethers to determine the effectiveness of each in inducing the basal production of isoflavones in cotyledon tissues (effector studies). In the elicitor studies, the addition of diphenyl ether first “primes” the cut cotyledon. That is, the competency for the elicitation of the phytoalexin glyceollin in response to the glucan elicitor from Phytophthora sojae is already partially activated by the prior addition of a diphenyl ether. As a result, the diphenyl ether-induced, increased levels of daidzein, which is the precursor for glyceollin, are rapidly converted into glyceollin in the presence of the glucan. Thus, the ability of a compound to enhance glyceollin elicitation competency by “loading” the isoflavone pools can also be measured.

Cotyledons from 7-8 day old soybean seedlings are removed from the plant and cut on the lower surface to expose subepidermal tissues. In experiments designed to study only the actions of the effector, cotyledons are treated with a 15 ul dose of a diphenyl ether or water (control). In the elicitor studies, the cotyledons are further treated with 15 ul of the glucan defense elicitor (30 ug/ml) from the fungal pathogen Phytophthora sojae or water (control), immediately after the addition of the diphenyl ether. Ten cotyledons are used per treatment and arranged in a petri plate containing a wet filter paper to keep the cotyledons moist. After incubation at room temperature under approximately 200 ueinsteins of light for 48 h, cotyledon tissues are harvested for analysis. Tissues for analysis are harvested by cutting a vertical column of cells from the cotyledon using a number 1 cork borer. The column of cells is then subsampled by cutting slices of cells progressively away from the original cut surface. The first section is approximately 4 cell layers thick and the second two are approximately 8 cell layers thick. These allow the examination of proximal and distal effects of treatments, respectively. Tissues are analyzed by HPLC as noted below. Full details of this assay can be found in the publication: Graham, T. L., and Graham, M. Y. 1991. Glyceollin Elicitors Induce Major But Distinctly Different Shifts in Isoflavonoid Metabolism in Local and Distal Cell Populations. Mol. Plant Microbe Inter. 4:60-68.

Snapped Cotyledon Assay

The snapped cotyledon assay is a minimal wound assay used to investigate the effects of test compounds in a non-primed background. The assay is performed by snapping cotyledons in two and placing the petiole side down in 0.5% water agar. Ten snapped cotyledons are used per treatment, and the subepidermal cells exposed by snapping are treated with glucan defense elicitor and/or the effector (i.e., diphenyl ether) being examined. The cotyledons are incubated in the light for 48 h as in the cut cotyledon assay. Both proximal (first cell layer) and distal (second and third cell layers) are harvested for analysis by HPLC (see below). Full details of this assay can be found in the publication: Graham, T. L. and Graham, M. Y. 1996. Signaling in soybean phenylpropanoid responses: dissection of primary, secondary and conditioning effects of light, wounding and elicitor treatments. Plant Physiol. 110:1123-1133.

The snapped cotyledon assay is “naive.” That is, it is not pre-disposed or primed for competency for the elicitation of phytoalexin glyceollin in response to the glucan elicitor. Thus, treatment with the glucan elicitor induces the formation of the isoflavones daidzein and genistein, but very little glyceollin. This is an excellent assay to study the effects of a chemical treatment on isoflavone metabolism by itself or in combination with the glucan. In the absence of the glucan, it gives an excellent picture of the effects of the compound alone on isoflavone metabolism. In the presence of the glucan, it tells us if the test compound can induce elicitation competency for the glyceollin response to the glucan.

4. HPLC Analysis of Isoflavone Levels in Cotyledons Treated with Diphenyl Ethers

High performance liquid chromatography (HPLC) is the method of choice for determining the levels of isoflavone defense compounds in soybean. With a single HPLC analysis, one gets a complete and quantitative profile of up to 50 or more aromatic compounds, including all the isoflavones and their conjugates and the phytoalexins, including glyceollin. As little as 20 mg of plant tissue is needed and the method can be readily applied to cotyledon, leaf or any soybean tissue. This analytical method allows us to determine the nmoles/g of each metabolite, which can then readily be processed to compare the percent increase or decrease of a given metabolite in comparison to either water or glucan-treated control tissues. Routinely, tissues are extracted in 80% ethanol and subjected to water/acetonitrile gradient elution from a C18 reverse phase HPLC column. Full details of this procedure can be found in the publication: Graham, T. L. 1991. A Rapid, High Resolution High Performance Liquid Chromatography Profiling Procedure for Plant and Microbial Aromatic Secondary Metabolites. Plant Physiol. 95:584-593.

### EXAMPLES

The following examples are merely illustrative of the preferred aspects of the invention and are not to be construed as limiting in any way.

### Example 1

### Field Studies on the Effects of Lactofen on Soybean Crops

A) This example demonstrates the effects of a formulation, comprising lactofen, a surfactant and ammonium sulfate, in triggering ISR in soybeans, as evidenced by soybeans protection against attack by the pathogen S. sclerotiorum. The form of lactofen used in the example was Cobra®. The form of the surfactant used was Induce®. Roundup® Ultra was also included in some of the formulations for weed control in the test plots. Five different formulations were prepared, each in 15 gallon batches. The identity and concentration of the ingredients in each formulation is listed in Table 1, Column 1.

Four treatments were arranged in a randomized complete block design (RCBD) so that statistical analysis of variance (ANOVA) could be performed on the results. Four replications (plots) were established for each of the four treatments. Each plot measured 25 feet by 200 feet. Each plot received an application of a different formulation on Day 40, when three of the trifoliate leaves had opened and the fourth was cupped, at the V3 growth stage. Each formulation was applied using a tractor boom sprayer, calibrated to deliver 15 gallons per acre. Formulations 1, 2, 3 and 4 were applied to each of the four plots in treatments 1, 2, 3 and 4, respectively, on day 40. On day 47, the four plots in treatment 4 received an application of formulation 5.

On Day 104, individual soybean plants in five row sections (each section measured 5 feet) were randomly selected in each of the four treatments, and inspected for evidence of S. sclerotiorum attack. Evidence of S. sclerotiorum attack includes both an area of the stem that is brown with white mycellium and general plant wilting. After it was found that the area of the field in which one replication of each of the treatments was located had no incidence of disease, inspections were made only in the other three replications of each of the four treatments. The mean results of the inspections in each of the four treatment (three replications) are outlined in Table 1, Column 4. On Day 110, individual soybean plants in each of the four treatments (three replications) were again inspected for evidence of S. sclerotiorum attack. The mean results of the inspections of the three replications of each treatment are outlined in Table 1, Column 5. Analysis of variance was conducted using the Student-Newman-Keuls test. Means followed by the same letter do not significantly differ.

On Day 142, the soybean plants from each of the four treatments were harvested. Yield means from the three replications of each treatment, adjusted to 13% moisture, are outlined in Table 1, Column 6. The mean moisture content of plants from each plot was also determine on the same date, and the results are outlined in Table 1, Column 7.

These results demonstrate that the formulations applied to treatments 2, 3 and 4 each significantly reduced the incidence of S. sclerotiorum attack, compared to treatment 1. While treatment 2, 3, and 4 each received a formulation containing the diphenyl ether lactofen, treatment 1 did not. Moreover, ISR protection was maintained for the length of the growing season in treatments 2 and 3, 60 days after application of the formulations to the individual plots. The results also demonstrate that the plants harvested from treatments 2 and 3 produced numerically higher yields of soybeans that treatment 1, and plants harvested from treatment 4 produced significantly higher yields than treatment 1. This indicates that the induction of systemic resistance results in a plant that is more healthy and vigorous, leading to higher yields. As seen in Table 1, the percent moisture in plants harvested from each of the four plots was not significantly different, indicating that the infestation and yield results were not influenced by the ability of the plants to absorb and maintain moisture.

TABLE 1

| | | | | | | | | | Yield | |
|---|---|---|---|---|---|---|---|---|---|---|
| | | | | | | | | | (bushel/ | |
| | | | | | | | | | acre) | |
| | | | Day 104 | | Day 110 | | | | (adjusted | |
| | | Day of | percent | | percent | | Percent | | to 13% | |
| | Treatment | treatment | infestation | | infestation | | moisture | | moisture) | |
| Treatment 1 | Roundup Ultra: 24 fl. oz/acre | 40 | 13.83 | a | 22.90 | a | 15.37 | a | 48.67 | b |
| | Induce: 4.8 fl. oz/acre | | | | | | | | | |
| | ammonium sulfate: 2 | | | | | | | | | |
| | lbs./acre | | | | | | | | | |
| Treatment 2 | Cobra: 6 fl. oz/acre | 40 | 4.83 | b | 9.00 | b | 15.40 | a | 55.95 | ab |
| | Roundup Ultra: 24 fl. oz/acre | | | | | | | | | |
| | Induce: 4.8 fl. oz/acre | | | | | | | | | |
| | ammonium sulfate: 2 | | | | | | | | | |
| | lbs./acre | | | | | | | | | |
| Treatment 3 | Cobra: 6 fl. oz/acre | 40 | 3.73 | b | 8.50 | b | 15.37 | a | 52.57 | ab |
| | Roundup Ultra: 24 fl. oz/acre | | | | | | | | | |
| | ammonium sulfate: 2 | | | | | | | | | |
| | lbs./acre | | | | | | | | | |
| Treatment 4 | Roundup Ultra: 24 fl. oz/acre | 40 | 0.83 | b | 3.00 | b | 15.37 | a | 61.00 | a |
| | ammonium sulfate: 2 | | | | | | | | | |
| | lbs./acre | | | | | | | | | |
| | Cobra: 6 fl. oz/acre | 47 | | | | | | | | |
| | Induce: 4.8 fl. oz/acre | | | | | | | | | |
| | ammonium sulfate: 2 | | | | | | | | | |
| | lbs./acre | | | | | | | | | |

Formulations in italics are the controls. Means followed by the same letter do not significantly differ (P = .05, Student-Newman-Keuls).

B) Table 2 summarizes the results from a number of experimental field studies performed on various farms in Ohio, Illinois and Pa. While a number of factors varied from farm to farm (e.g. form of lactofen used, composition of the formulations, composition of the controls, weather conditions, soil conditions, planting conditions, etc.), as can be seen from Table 2, soybean crops treated with lactofen-containing formulations had significantly reduced incidences of S. sclerotiorum damage compared to soybeans treated with control formulations lacking lactofen. Moreover, crop yields from lactofen-treated plots were generally higher than that of control plots. Moisture content did not significantly vary between those plants receiving lactofen and the controls.

The form of lactofen used in these field trials was either Cobra® or Stellar®. The adjuvants used in one or more formulations of this example were crop oil concentrates, non-ionic surfactants, ammonium sulfate, and urea ammonium nitrate. Other active chemicals used in one or more formulations of this example were the herbicides Roundup® Ultra, Python®, Select®, Firstrate®, and Pinnacle®.

TABLE 2

| | | | | | | Yield |
|---|---|---|---|---|---|---|
| | | | | | | (bushel/ |
| | | | | | | acre) |
| | Soybean | | | | | (adjusted |
| | maturity | Row | | Percent | Percent | to 13% |
| Location | group | width | Treatment | infestation | moisture | moisture) |
| Mt. Vernon, | 3.6 | 7″ | Cobra: 8.5 fl. oz/acre | 3 | 11.3 | 52.5 |
| OH | STS | | crop oil concentrate: 16 fl. oz/acre | | | |
| | | | Untreated post-emergence | 65 | 11.9 | 37.6 |
| Mt. Vernon, | 3.6 | 7″ | Cobra: 8.5 fl. oz/acre | 3 | 11.7 | 49.8 |
| OH | STS | | crop oil concentrate: 16 fl. oz/acre | | | |
| | | | Untreated post-emergence | 50 | 11.9 | 40.3 |
| Mt. Vernon, | 3.0 | 7″ | Cobra: 8.5 fl. oz/acre | 1 | 12.97 | 54.12 |
| OH | RR | | Roundup Ultra: 32 fl. oz/acre | | | |
| | | | crop oil concentrate: 16 fl. oz/acre | | | |
| | | | ammonium sulfate: 2.5 lbs./acre | | | |
| | | | Stellar: 5 fl. oz/acre | 3 | 13.13 | 53.40 |
| | | | Roundup Ultra: 32 fl. oz/acre | | | |
| | | | crop oil concentrate: 16 fl. oz/acre | | | |
| | | | ammonium sulfate: 2.5 lbs./acre | | | |
| | | | Roundup Ultra: 32 fl. oz/acre | 20-24 | 13.36 | 50.73 |
| | | | ammonium sulfate: 2.5 lbs./acre | | | |
| Hicksville, | 3.1 | 7″ | Pre-emerge: Python: 1 fl. oz/acre | 5 | ND | 58.8 |
| OH | | | Cobra: 8 fl. oz/acre | | | |
| | | | Select: 8 fl. oz/acre | | | |
| | | | crop oil concentrate: 1% v/v | | | |
| | | | urea ammonium nitrate: 32 fl. oz/acre | | | |
| | | | Pre-emerge: Python: 1 fl. oz/acre | 25 | ND | 55.8 |
| | | | Firstrate: 0.3 fl. oz/acre | (a late | | |
| | | | Select: 6 fl. oz/acre | infection) | | |
| | | | crop oil concentrate: 1% v/v | | | |
| Erie County, | 1.9 | 7″ | Cobra: 6 fl. oz/acre | 14.6 | ND | 47.22 |
| PA | | | | | | |
| | | | Untreated post-emergence | 58.0 | ND | 39.72 |
| Liberty | 3.1 | 30″ | Cobra: 4 fl. oz/acre | 0 | 11.2 | 63.7 |
| Center, OH | | | non-ionic surfactant: 0.25% v/v | | | |
| | | | Cobra: 8 fl. oz/acre | 0 | 11.2 | 62.8 |
| | | | crop oil concentrate: 0.125% v/v | | | |
| | | | Untreated post-emergence | 2 | 11.6 | 63.9 |
| Genoa, IL | 2.6 | 30″ | Cobra: 4 fl. oz/acre | <5 | ND | 62.2 |
| | | | Cobra: 4 fl. oz/acre | <5 | ND | 62.1 |
| | | | Cobra: 4 fl. oz/acre | <5 | ND | 60 |
| | | | Untreated post-emergence | 20 | ND | 57.5 |
| Woodstock, | 1.9 | 7″ | Cobra: 6 fl. oz/acre | 5-10 | 15.9 | 52.2 |
| IL | | | crop oil concentrate: 0.125% v/v | | | |
| | | | Untreated post-emergence | 50 | 15.7 | 49 |
| Woodstock, | 1.9 | 7″ | Cobra: 6 fl. oz/acre | 5-10 | 15.2 | 56.2 |
| IL | | | crop oil concentrate: 0.125% v/v | | | |
| | | | Cobra: 6 fl. oz/acre | 5-10 | 15 | 59.3 |
| | | | crop oil concentrate: 0.125% v/v | | | |
| | | | Untreated post-emergence | 50 | 15.3 | 49.4 |
| Woodstock, | 2.2 | 7″ | Cobra: 6 fl. oz/acre | <5 | 12.8 | 51.5 |
| IL | | | crop oil concentrate: 0.125% v/v | | | |
| | | | Untreated post-emergence | 20 | 12.7 | 48.2 |
| Woodstock, | 2.2 | 7″ | Cobra: 6 fl. oz/acre | 5-10 | 13.8 | 51.5 |
| IL | | | crop oil concentrate: 0.125% v/v | | | |
| | | | Cobra: 6 fl. oz/acre | 5-10 | 13.7 | 50 |
| | | | crop oil concentrate: 0.125% v/v | | | |
| | | | Untreated post-emergence | 40 | 13.9 | 45.1 |

Formulations in italics are the controls

C) Additional field studies demonstrated that ISR triggered by lactofen protected soybean crops against attack by Phytophthora sojae. Soybean seeds (Pioneer 93B01 RR) were planted in plots measuring 25 by 300 feet. Treatments were replicated three times in a RCBD. Two separate trials were established in the same field. Lactofen was applied at the R1 growth stage (Day 1). On Day 64, ten samples were taken from each plot, each sample comprised of the plants in a five foot long section of a row. Each plant in each sample was examined for evidence of P. sojae. Table 3 summarizes the results of this study. As can be seen from the results, lactofen significantly reduced P. sojae growth and increase overall crop yield.

TABLE 3

| | | | | | Yield (bushel/acre) | |
|---|---|---|---|---|---|---|
| | | | Percent | | (adjusted to 13% | |
| | Trial | Treatment | infestation | | moisture) | |
| Treatment 1 | 1 | Roundup Ultra: 32 fl. oz/acre | 10.6 | a | 49.23 | a |
| | | ammonium sulfate: 2 lbs./acre | | | | |
| Treatment 2 | 1 | Cobra: 6 oz/acre | 2.07 | b | 52.88 | b |
| | | Roundup Ultra: 32 fl. oz/acre | | | | |
| | | non-ionic surfactant: 4.8 fl. oz/acre | | | | |
| | | ammonium sulfate: 2 lbs./acre | | | | |
| Treatment 1 | 2 | Roundup Ultra: 32 fl. oz/acre | 19.0 | c | 41.32 | c |
| | | ammonium sulfate: 2 lbs./acre | | | | |
| Treatment 2 | 2 | Cobra: 6 oz/acre | 6.3 | d | 44.75 | cd |
| | | Roundup Ultra: 32 fl. oz/acre | | | | |
| | | ammonium sulfate: 2 lbs./acre | | | | |
| Treatment 3 | 2 | Cobra: 6 oz/acre | 4.3 | d | 45.23 | cd |
| | | Roundup Ultra: 32 fl. oz/acre | | | | |
| | | non-ionic surfactant: 4.8 fl. oz/acre | | | | |
| | | ammonium sulfate: 2 lbs./acre | | | | |
| Treatment 4 | 2 | Cobra: 6 oz/acre | 4.7 | d | 47.76 | c |
| | | Roundup Ultra: 32 fl. oz/acre | | | | |
| | | non-ionic surfactant: 4.8 fl. oz/acre | | | | |
| | | ammonium sulfate: 2 lbs./acre | | | | |
| | | VRB: 2.8 grams/acre | | | | |

Formulations in italics are the controls. Means followed by the same letter do not differ significantly (P = .05, Student-Newman-Keuls).

D) Further field studies demonstrated that ISR triggered by lactofen protected soybean crops against sudden death syndrome, caused by F solani f.sp. glycines. Soybean seeds (BSR 101, Asgrow A 3701 (RR) variety, or Pioneer P9344 (RR)) were planted in soil infested with F. solani f.sp. glycines. Treatments were at 1×rate and applied at the vegetative state. As can be seen from the results below, lactofen significantly reduced damage cause by F. solani f.sp. glycines.

[image]

E) Greenhouse studies further demonstrated that ISR triggered by lactofen protected soybean crops against sudden death syndrome caused by F. solani f.sp. glycines. Soybean seeds (BSR 101, Asgrow A 3701 (RR) variety, or Pioneer P9344 (RR)) were planted in soil infested with F. solani f.sp. glycines. Treatments were at 1 X rate and applied at the vegetative state.

Periodic isolation of the pathogen from roots of these plants showed significant reduction of root infection, measured by root rot severity. The reduction in soybean root colonization of F. solani f.sp. glycines after foliar application of lactofen indicates that the induced resistance to F. solani f.sp. glycines is systemic.

[image]

### EXAMPLE 2

### Variation in Time of Lactofen Application to Soybeans

A field study was conducted on a farm near Muncy, Pa. to determine whether varying the time at which lactofen application took place had any effect on ISR, as evidenced by suppression of S. sclerotiorum growth. Soybean seeds (Pioneer 9352) were planted in rows 14″ apart. Four treatments were arranged in a RCBD with four replications per treatment. Treatment 1 was the untreated control. Treatment 2 received only the crop oil concentrate. Treatment 3 received Cobra® and crop oil concentrate when soybean plants were at the V4 growth stage (Day 1). Treatment 4 received Cobra® and crop oil concentrate when soybean plants were at the R1 growth stage (Day 12). As can be seen from the results, summarized in Table 4, the timing of lactofen application had no significant effect on the ISR-inducing ability of lactofen.

TABLE 4

| | | | | | | | Yield | |
|---|---|---|---|---|---|---|---|---|
| | | | Day 53 | | | | (bushel/acre) | |
| | | Date of | percent | | Percent | | (adjusted to | |
| | Treatment | application | infestation | | moisture | | 13% moisture) | |
| Plot 1 | Untreated | — | 32.30 | a | 11.90 | a | 48.20 | a |
| Plot 2 | crop oil concentrate: 16 fl. oz/acre | Day 1 | 34.30 | a | 11.50 | a | 52.20 | a |
| Plot 3 | Cobra: 8 fl. oz/acre | Day 1 | 5.00 | b | 11.63 | a | 55.90 | a |
| | crop oil concentrate: 16 fl. oz/acre | | | | | | | |
| Plot 4 | Cobra: 8 fl. oz/acre | Day 12 | 7.30 | b | 11.37 | a | 56.30 | a |
| | crop oil concentrate: 16 fl. oz/acre | | | | | | | |

Formulations in italics are the controls. Means followed by the same letter do not differ significantly (P = .05, Student-Newman-Keuls).

### EXAMPLE 3

### Field Studies on the Effects of Lactofen On Soybean Crop Yields

Table 5 summarizes the results of crop yield measurements, comparing lactofen-treated soybeans with control plants. The soybeans were harvested from farms in Ohio. While a number of factors varied from farm to farm (e.g. form of lactofen used, composition of the formulations, composition of the controls, weather conditions, soil conditions, etc.), as can be seen from Table 5, soybean crops treated with lactofen-containing formulations generally had increased yields compared to control plots. Moisture content did not significantly vary between those plants receiving lactofen and the controls.

The form of lactofen used in these field trials was either Cobra® or Stellar®. The adjuvants used in one or more formulations of this example were crop oil concentrates and ammonium sulfate. Roundup® Ultra was also used in a number of the formulations.

TABLE 5

| | | | | | Yield | |
|---|---|---|---|---|---|---|
| | Soybean | | | | (bushel/acre) | Percent |
| | maturity | Row | | Percent | (adjusted to | increase in |
| Location | group | width | Treatment | moisture | 13% moisture) | yield |
| Danville | 3.4 | 7″ | Cobra: 6 fl. oz/acre | 13.1 | 34.00 | 8.7 |
| | RR | | Roundup Ultra: 32 fl. oz/acre | | | |
| | | | crop oil concentrate: 16 fl. oz/acre | | | |
| | | | ammonium sulfate: 17% w/v | | | |
| | | | Roundup Ultra: 32 fl. oz/acre | 13.3 | 31.03 | |
| | | | ammonium sulfate: 17% w/v | | | |
| Mt. | 2.9 | 7″ | cobra: 6 fl. oz/acre | 12.8 | 57.4 | 4.4 |
| Vernon | RR | | Roundup Ultra: 32 fl. oz/acre | | | |
| | | | crop oil concentrate: 16 fl. oz/acre | | | |
| | | | ammonium sulfate: 2.5 lbs./acre | | | |
| | | | Roundup Ultra: 32 fl. oz/acre | 12.7 | 54.9 | |
| | | | ammonium sulfate: 2.5 lbs./acre | | | |
| | | | Stellar: 5 fl. oz/acre | 12.7 | 57.9 | 2.6 |
| | | | Roundup Ultra: 32 fl. oz/acre | | | |
| | | | crop oil concentrate: 16 fl. oz/acre | | | |
| | | | ammonium sulfate: 2.5 lbs./acre | | | |
| | | | Roundup Ultra. 32 fl. oz/acre | 13.1 | 56.4 | |
| | | | ammonium sulfate: 2.5 lbs./acre | | | |
| Mt. | 3.3 | 7″ | Stellar: 5 fl. oz/acre | 12.1 | 59.9 | 4.3 |
| Vernon | RR | | Roundup Ultra: 32 fl. oz/acre | | | |
| | | | crop oil concentrate: 16 fl. oz/acre | | | |
| | | | ammonium sulfate: 2.5 lbs./acre | | | |
| | | | Roundup Ultra: 32 fl. oz/acre | 13.2 | 57.3 | |
| | | | ammonium sulfate: 2.5 lbs./acre | | | |
| Napoleon | 2.0 | 7″ | Cobra: 6 fl. oz/acre | 13.7 | 80.3 | 3.4 |
| | | | crop oil concentrate: 32 fl. oz/acre | | | |
| | | | Untreated | 14.4 | 77.58 | |
| Napoleon | 1.7 | 7″ | Cobra: 6 fl. oz/acre | 12.9 | 71.98 | 0.46 |
| | | | crop oil concentrate: 32 fl. oz/acre | | | |
| | | | Untreated | 13.1 | 71.65 | |
| Napoleon | 1.9 | 7″ | Cobra: 6 fl. oz/acre | 12.9 | 79.47 | 6.6 |
| | | | crop oil concentrate: 32 fl. oz/acre | | | |
| | | | Untreated | 13.1 | 74.21 | |
| Napoleon | X2.0 | 7″ | Cobra: 6 fl. oz/acre | 16.6 | 70.92 | 3.6 |
| | | | crop oil concentrate: 32 fl. oz/acre | | | |
| | | | Untreated | 14.0 | 68.38 | |
| Napoleon | 3.0 | 7″ | Cobra: 6 fl. oz/acre | 14.0 | 77.09 | 0.3 |
| | | | crop oil concentrate: 32 fl. oz/acre | | | |
| | | | Untreated | 13.0 | 76.86 | |
| Napoleon | 2.4 | 7″ | Cobra: 6 fl. oz/acre | 12.6 | 73.80 | none |
| | | | crop oil concentrate: 32 fl. oz/acre | | | |
| | | | Untreated | 12.6 | 74.35 | |

Formulations in italics are the controls.

### EXAMPLE 4

### Induction of Isoflavone Levels as Shown by Treatment of Snapped Cotyledons

Plant material: cotyledons were isolated from 7 day old Williams variety soybean; 10 cotyledons were assayed per treatment.

Formulation/composition: diphenyl ethers tested include lactofen, fomesafen, and acifluorfen. The diphenyl ether was dissolved either in water or first in isopropanol to give a saturated solution followed by rapid dilution in water. Final concentration of isopropanol did not exceed 0.5%. The diphenyl ethers were tested over a concentration range of about 10 uM to 1 mM, using serial 3 fold dilutions from 1 mM. Diphenyl ethers were tested both alone and in the presence of 30 ug/ml of the glucan elicitor from the fungal pathogen Phytophthora sojae. Concentrations of the diphenyl ether and glucan noted here were final concentrations on the treated cotyledon.

Treatment: the exposed surface of each snapped cotyledon was treated with 7 uL of the diphenyl ether being tested, followed by 7 uL of the glucan or water. Cotyledons were incubated in constant light (200 uEinsteins) for 48 h.

Analysis: at 48 h, a thin (translucent) section was harvested from the treated cotyledon surface. Sections from the 10 cotyledons for each treatment were pooled and extracted in 80% ethanol (400 uL for each 50 mg fresh weight). The extract was then subjected to HPLC as described above. The results, shown in Table 6, indicate that each of the diphenyl ethers were capable of both inducing basal levels of isoflavones, and “priming” glyceollin competency. Values are the average of two separate experiments. The standard error was less than 15% of the average for all values.

TABLE 6

| | | Glyceollin |
|---|---|---|
| Compound | Total Isoflavone Induction | Induction |
| Fomesafen | +85% | +233% |
| Lactofen | +64% | +181% |
| Acifluorfen | +56% | +122% |

Additional diphenyl ethers were tested in the cut cotyledon assay (Williams cotyledons) over a range of concentrations from 50-500 uM. The activity of thyroxine, expressed as the range of increase of isoflavones over the concentration range was 20-40%.

### EXAMPLE 5

### Induction of Isoflavone Levels in other Plants and Plant Organs

A) Legumes including lima bean, mung bean, green bean, peanuts, and chickpeas were treated with compositions comprising lactofen in the cut cotyledon assay as described above in Example 4. The composition was applied to cotyledons of plants of appropriate age for the assay, that is, tissues which were fully expanded, green and non-senescent.

Lactofen was applied at a concentration of 100-200 uM. When 100 uM lactofen was applied to the cut cotyledons, increases ranging from 20-500% in aromatic metabolites in lima bean, chickpea, green bean and peanuts were observed. These aromatic metabolites were not identified specifically. However, their ultraviolet spectra suggest that many are isoflavones.

B) True leaves of soybean plants were also treated as described above in Example 4. For tests on true leaves of soybean or other plants, two methods were used. In the laboratory, a vacuum was used to infiltrate a small spot on the leaves using a filter disc platform hooked to a water aspirator. The leaf was placed on the filter disc platform and mild suction applied. A drop of the glucan elicitor and/or chemical treatment was then placed on the exposed surface of the leaf and allowed to infiltrate the tissue through the leaf stomatal pores. For the greenhouse or field, the chemical was applied in a formulation with a surfactant to emulsify and disperse the chemical. In each assay, the tissues were again analyzed by HPLC as described above.

Applied by infiltration into soybean leaf tissue, 100 uM lactofen caused a 6-fold increase in conjugates of the isoflavone genistein, and at least a 10-fold increase in the isoflavone daidzein, which is at nearly undetectable levels in mature soybean leaves.

C) Field and greenhgouse studies were also performed to determine whether direct application of lactofen to soybean leaves would induce increased levels of the aglycones of daidzein and genistein, and conjugates of genistein. Table 7 below shows the response of leaf tissues to lactofen as a percent increase over the appropriate control treatment. In the field (Ohio or Pennsylvania), Cobra was applied at 6 oz/acre and leaves were analyzed 8 days after treatment. In the greenhouse, lactofen was applied at 50 micromolar and the leaves were analyzed 48 hours after treatment.

As is evident from the results, soybean leaves respond to lactofen by producing very large increases in the aglycones of daidzein and genistein, and conjugates of genistein.

TABLE 7

| | Increase in | Increase in | Increase in |
|---|---|---|---|
| | Genistein | Daidzein | Genistein |
| | Conjugates | Aglycone | Aglycone |
| Leaf Tissue Analyzed | over control | over control | over control |
| Cobra treated field | 6× | 4× | 38× |
| trifoliates - OH | | | |
| Cobra treated field | 2× | 3× | 40× |
| trifoliates - PA | | | |
| Lactofen-infiltrated | 6× | 11× | 41× |
| greenhouse trifoliates | | | |
| Lactofen-sprayed | 5× | 6× | 62× |
| greenhouse trifoliates | | | |

### EXAMPLE 6

### Induction of Isoflavone Levels in Soybean Seeds

Analyses were made to determine daidzein, conjugated daidzein, genistein, and conjugated genistein levels separately at two node locations per plot (3 soybean plants were sampled per plot). Results are given as a total amount of the four named isoflavones. The values determined for the lower node samples were added to the values of the upper node samples, and the resulting value was divided by 2 to give a mean isoflavone level for each plot. A total of 3 field replications (randomized complete block design) were made of each treatment times 2 samples per plot =6 samples per treatment.

A) Chemgro 2289 was planted in a field at Port Farms, Waterford, Pa. Applications were made Jun. 24, 1999, at stage V4/V5. Soybeans were harvested on Oct. 6, 1999, 104 days after treatment. Leaf samples were taken on 4 DAT and 45 DAT for analysis. No ratable disease occurred in these plots. Yields were measured on Oct. 7, 1999. No yield differences between treatments was found. For total isoflavone calculations: LSD (P=0.05)=1951.141; SD=555.345; CV=2.24; treatment probability (F)=0.0125.

TABLE 8

| | Total |
|---|---|
| Treatment | isoflavone (nM) |
| Firstrate 84 WDG: 0.3 oz/acre | 22770.67 b |
| Select 2EC: 6 fl. oz/acre | |
| Dyn-amic: 0.4% V/V | |
| Firstrate 84 WDG: 0.3 oz/acre | 26795.67 a |
| Cobra 2EC: 6 fl. oz/acre | |
| Select 2EC: 6 fl. oz/acre | |
| Dyn-amic: 0.4% V/V | |

Formulations in italics are the controls. Means followed by the same letter do not differ significantly (P = .05, Student-Newman-Keuls).

B) Garst 261 RR was planted in a field at Port Farms, Waterford, Pa. Applications were made Jun. 24, 2000, at early R1. Soybeans were harvested on Oct. 6, 1999. No ratable disease occurred in these plots. Yields were measured on Oct. 7, 1999. No yield differences between treatments was found. For total isoflavone calculations: LSD (P=0.05)=3025.34; SD=1334.75; CV=7.4; treatment probability (F)=0.6493.

TABLE 9

| | Total |
|---|---|
| Treatment | isoflavone (nM) |
| Roundup Ultra: 1 qt/acre | 17811 a |
| AMS: 2.0 lbs/acre | |
| Roundup Ultra: 1 qt/acre | 17651.17 a |
| Cobra 2EC: 6 fl. oz/acre | |
| AMS: 2.0 lbs/acre | |
| Roundup Ultra: 1 qt/acre | 18647.33 a |
| Cobra 2EC: 4.7 fl. oz/acre | |
| VRB: 30 mg/L | |

Formulations in italics are the controls. Means followed by the same letter do not differ significantly (P = .05, Student-Newman-Keuls).

C) Group 1.9 RR soybeans were planted in a field at Port Farms, Waterford, Pa. Applications were made Jun. 24, 1999, at early R1. Soybeans were harvested on Oct. 6, 1999. No ratable disease occurred in these plots. Yields were measured on Oct. 7, 1999. No yield differences between treatments was found. For total isoflavone calculations: LSD (P=0.05)=2536.3; SD=721.9; CV=3.57; treatment probability (F)=0.6225.

TABLE 10

| | Total |
|---|---|
| Treatment | isoflavone (nM) |
| Roundup Ultra: 1 qt/acre | 20402.67 a |
| AMS: 2.0 lbs/acre | |
| Roundup Ultra: 1 qt/acre | 20062.83 a |
| Cobra 2EC: 6 fl. oz/acre | |
| AMS: 2.0 lbs/acre | |

Formulations in italics are the controls. Means followed by the same letter do not differ significantly (P = .05, Student-Newman-Keuls).

D) Pioneer 93B01 RR was planted in a field at Springer Farm, Mt. Vernon, Ohio. Applications were made Jun. 30, 1999. Soybeans were harvested on Oct. 26, 1999. Phytophthora m. was present and was rated on Sep. 2, 1999. Cobra treatments provided significant reduction in Phytophthora incidence and resulted in a significant yield increase. For total isoflavone calculations: LSD (P=0.05)=3835.87; SD=1919.86; CV=9.36; treatment probability (F)=0.153.

TABLE 11

| | Total |
|---|---|
| Treatment | isoflavone (nM) |
| Roundup Ultra: 1 qt/acre | 18713.67 a |
| AMS: 2.0 lbs/acre | |
| Roundup Ultra: 1 qt/acre | 22943.83 a |
| Cobra 2EC: 6 fl. oz/acre | |
| AMS: 2.0 lbs/acre | |
| Surfactant: 0.25% V/V | |
| Roundup Ultra: 1 qt/acre | 20215.33 a |
| VERG: 300 mg/L | |
| Acetone | |
| Tween 20: 1% V/V | |
| Roundup Ultra: 1 qt/acre | 20169.67 a |
| VRB: 80 mg/L | |
| Surfactant: 0.25% V/V | |

Formulations in italics are the controls. Means followed by the same letter do not differ significantly (P = .05, Student-Newman-Keuls).

E) Pioneer 93B01 RR was planted in a field at Springer Farm, Mt. Vernon, Ohio. Applications were made Jun. 30, 1999. Soybeans were harvested on Oct. 26, 1999. Phytophthora m. was present and was rated on Sep. 2, 1999. Cobra treatments provided significant reduction in Phytophthora incidence and resulted in a significant yield increase. For total isoflavone calculations: LSD (P=0.05)=4189.86; SD=2097.06; CV=10.47; treatment probability (F)=0.2878.

TABLE 12

| | Total |
|---|---|
| Treatment | isoflavone (nM) |
| Roundup Ultra: 1 qt/acre | 21251 a |
| AMS: 2.0 lbs/acre | |
| Roundup Ultra: 1 qt/acre | 19534.67 a |
| Cobra 2EC: 6 fl. oz/acre | |
| AMS: 2.0 lbs/acre | |
| Roundup Ultra: 1 qt/acre | 21221.33 a |
| Cobra 2EC: 6 fl. oz/acre | |
| Surfactant: 0.25% V/V | |
| Roundup Ultra: 1 qt/acre | 18073 a |
| Cobra 2EC: 3 fl. oz/acre | |
| VRB: 50 mg/L | |
| Surfactant: 0.25% V/V | |

Formulations in italics are the controls. Means followed by the same letter do not differ significantly (P = .05, Student-Newman-Keuls).

F) Ohio FG1 was planted in a field at Profit Farm, Van Wert, Ohio. Applications were made Jul. 20, 2000. Soybeans were harvested at the end of the normal growing season. For total isoflavone calculations: LSD (P=0.05)=524.66; SD=233.18.

TABLE 13

| | Total |
|---|---|
| Treatment | isoflavone (nM) |
| No treatment | 4479.5 a |
| Cobra 2EC: 2 fl. oz/acre | 4761.3 a |
| Fertilizer: 3.0 gal/acre | |

Formulations in italics are the controls. Means followed by the same letter do not differ significantly (P = .05, Student-Newman-Keuls).

G) Ohio FG1 was planted in a field at Profit Farm, Van Wert, Ohio. Applications were made Jul. 13, 2000. Soybeans were harvested at the end of the normal growing season. For total isoflavone calculations: LSD (P=0.05)=407.05; SD=180.91.

TABLE 14

| | Total |
|---|---|
| Treatment | isoflavone (nM) |
| No treatment | 5189 a |
| Cobra 2EC: 3 fl. oz/acre | 5147.3 a |
| Fertilizer: 3.0 gal/acre | |
| Pro-X: 1 pint/acre | |

Formulations in italics are the controls. Means followed by the same letter do not differ significantly (P = .05, Student-Newman-Keuls).

H) Ohio FG1 was planted in a field at Profit Farm, Van Wert, Ohio. Applications were made Jul. 10, 2000. Soybeans were harvested at the end of the normal growing season. For total isoflavone calculations: LSD (P=0.05)=1137.79; SD=505.68.

TABLE 15

| | Total |
|---|---|
| Treatment | isoflavone (nM) |
| No treatment | 4816.8 a |
| Cobra 2EC: 4 fl. oz/acre | 5046 a |
| Fertilizer: 3.0 gal/acre | |

Formulations in italics are the controls. Means followed by the same letter do not differ significantly (P = .05, Student-Newman-Keuls).

I) Ohio FG1 was planted in a field at Profit Farm, Van Wert, Ohio. Applications were made Jul. 10, 2000. Soybeans were harvested at the end of the normal growing season. For total isoflavone calculations: LSD (P=0.05)=1355.94; SD 602.64.

TABLE 16

| | Total |
|---|---|
| Treatment | isoflavone (nM) |
| No treatment | 5164.3 a |
| Cobra 2EC: 2 fl. oz/acre | 5135.5 a |
| Fertilizer: 3.0 gal/acre | |

Formulations in italics are the controls. Means followed by the same letter do not differ significantly (P = .05, Student-Newman-Keuls).

J) Pioneer 9305 was planted in a field at St. Charles Seminary, Coldwater, Ohio. Applications were made Jul. 1, 2000. Soybeans were harvested at the end of the normal growing season. For total isoflavone calculations: LSD (P=0.05)=296.53; SD=131.79.

TABLE 17

| | Total |
|---|---|
| Treatment | isoflavone (nM) |
| Select 2EC: 6 fl. oz/acre | 3648 a |
| Firstrate: 0.3 fl. oz/acre | |
| Dynamic: 2 quarts/100 | |
| Cobra 2EC: 6 ft oz/acre | 4009.8 b |
| Select 2EC: 6 fl. oz/acre | |
| Firstrate 0.3 oz/acre | |
| Dynamic: 2 quarts/100 | |

Formulations in italics are the controls. Means followed by the same letter do not differ significantly (P = .05, Student-Newman-Keuls).

While the invention has been described in detail and with reference to specific embodiments thereof, it will be apparent to one of skill in the art that various changes and modifications can be made therein without departing from the spirit and scope thereof.

What is claimed is:

1. A method of triggering induced systemic resistance in a plant comprising, applying an effective amount of a biologically active formulation comprising a diphenyl ether to the surface of at least a part of the plant, triggering activation of induced systemic resistance in the plant, thereby inducing systemic resistance to at least one pathogen or disease.

2. The method of claim 1, wherein said diphenyl ether has a structure represented by one of the following formulas: 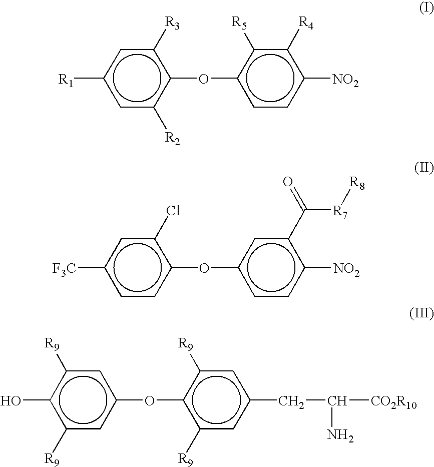
wherein R₁ is a hydrogen, fluorine, or chlorine atom, or a trifluoromethyl group; R₂, R₃ and R₅ are independently a hydrogen, fluorine, or chlorine atom; R₄ is a hydrogen atom, NR₆, NR₆OR₆, COOR₆, COOCHR₆CO₂R₆, CONHSO₂R₆, or a cyclic ether, wherein R₆ is a hydrogen atom, a branched alkyl group of 1 to 4 carbon atoms or a linear alkyl group of 1 to 4 carbon atoms;
wherein R₇ is an oxygen or nitrogen atom; and R₈ is a hydrogen atom, CH₃, an aliphatic chain comprising 2 to 5 carbon atoms, or HSO₂CH₃; and
wherein R₉ is H, Cl, I, Br or CF₃; and R₁₀ is a branched aliphatic chain comprising 1-5 carbon atoms.

3. The method of claim 2, wherein said diphenyl ether has a structure represented by formula (I).

4. The method of claim 3, wherein the diphenyl ether is acifluorfen, aclonifen, bifenox, chlomethoxyfen, chlornitrofen, fluorodifen, fluoroglycofen, fluoronitrofen, fomesafen, furyloxyfen, halosafen, lactofen, nitrofen, nitrofluorfen or oxyfluorfen.

5. The method of claim 4, wherein the diphenyl ether is lactofen.

6. The method of claim 1, wherein the formulation further comprises one or more adjuvants selected from phytologically acceptable carriers, crop oil concentrates, surfactants, fertilizers, emulsifiers, dispersing agents, foaming activators, foam suppressants, and correctives.

7. The method of claim 6, wherein the adjuvant is a surfactant.

8. The method of claim 7, wherein the adjuvant is a non-ionic surfactant.

9. The method of claim 6, wherein the adjuvant is a crop oil concentrate.

10. The method of claim 6, wherein the adjuvant is ammonium sulfate or urea ammonium nitrate.

11. The method of claim 1, wherein the formulation further comprises one or more other active chemicals.

12. The method of claim 11, wherein the one or more other active chemicals is a herbicide.

13. The method of claim 1, wherein the plant is a legume selected from lima bean, pinto bean or soybean.

14. The method of claim 13, wherein the legume is soybean.

15. The method of claim 1, wherein induced systemic resistance is triggered before the onset of disease due to said pathogen.

16. The method of claim 1, wherein induced systemic resistance lasts until the plant is harvested.

17. The method of claim 1, which further comprises applying to the surface of the plant a booster application of said formulation subsequent to the initial application, thereby inducing continued resistance to the pathogen.

18. A method of increasing plant yield comprising, applying an effective amount of a biologically active formulation comprising a diphenyl ether to the surface of at least a part of the plant, triggering activation of induced systemic resistance in the plant, and maintaining or increasing the general health of the plant, thereby increasing crop yield.

19. The method of claim 18, wherein said diphenyl ether has a structure represented by one of the following formulas: 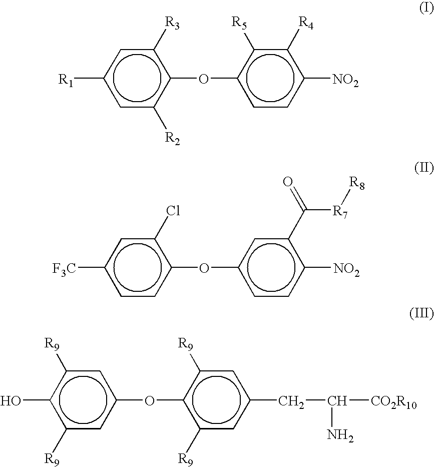
wherein R₁ is a hydrogen, fluorine, or chlorine atom, or a trifluoromethyl group; R₂, R₃ and R₅ are independently a hydrogen, fluorine, or chlorine atom; R₄ is a hydrogen atom, NR₆, NR₆R₆, OR₆, COOR₆, COOCHR₆CO₂R₆, CONHSO₂R₆, or a cyclic ether, wherein R₆ is a hydrogen atom, a branched alkyl group of 1 to 4 carbon atoms or a linear alkyl group of 1 to 4 carbon atoms;
wherein R₇ is an oxygen or nitrogen atom; and R₈ is a hydrogen atom, CH₃, an aliphatic chain comprising 2 to 5 carbon atoms, or HSO₂CH₃; and
wherein R₉ is H, Cl, I, Br or CF₃; and R₁₀ is a branched aliphatic chain comprising 1-5 carbon atoms.

20. The method of claim 19, where said diphenyl ether has a structure represented by formula (I).

21. The method of claim 20, wherein the diphenyl ether is acifluorfen, aclonifen, bifenox, chlomethoxyfen, chlomitrofen, fluorodifen, fluoroglycofen, fluoronitrofen, fomesafen, furyloxyfen, halosafen, lactofen, nitrofen, nitrofluorfen or oxyfluorfen.

22. The method of claim 21, wherein the diphenyl ether is lactofen.

23. The method of claim 18, wherein the formulation further comprises one or more adjuvant selected from phytologically acceptable carriers, crop oil concentrates, surfactants, fertilizers, emulsifiers, dispersing agents, foaming activators, foam suppressants, and correctives.

24. The method of claim 23, wherein the adjuvant is a surfactant.

25. The method of claim 24, wherein the adjuvant is a non-ionic surfactant.

26. The method of claim 23, wherein the adjuvant is a crop oil concentrate.

27. The method of claim 23, wherein the adjuvant is ammonium sulfate or urea ammonium nitrate.

28. The method of claim 18, wherein the formulation further comprises one or more other active chemicals.

29. The method of claim 28, wherein the one or more other active chemicals is a herbicide.

30. The method of claim 18, wherein the plant is a legume selected from lima bean, pinto bean or soybean.

31. The method of claim 30, wherein the legume is soybean.

32. The method of claim 18, wherein induced systemic resistance is formed before the onset of disease due to said pathogen.

33. The method of claim 18, wherein induced systemic resistance lasts until the plant is harvested.

34. The method of claim 18, which further comprises applying to the surface of the plant a booster application of said formulation subsequent to the initial application, thereby inducing continued resistance to the pathogen.

35. A method for increasing levels of an isoflavone in a plant comprising, applying an effective amount of a biologically active formulation comprising a diphenyl ether to the surface of at least a part of the plant, inducing release or production of an isoflavone in the plant, thereby increasing levels of an isoflavone in the plant.

36. The method of claim 35, wherein said diphenyl ether has a structure represented by one of the following formulas: 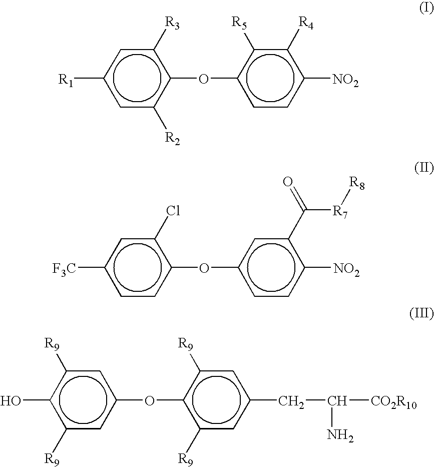
wherein R₁ is a hydrogen, fluorine, or chlorine atom, or a trifluoromethyl group; R₂, R₃ and R₅ are independently a hydrogen, fluorine, or chlorine atom; R₄ is a hydrogen atom, NR₆, NR6R₆, OR₆, COOR₆, COOCHR₆CO₂R₆, CONHSO₂R₆, or a cyclic ether, wherein R₆ is a hydrogen atom, a branched alkyl group of 1 to 4 carbon atoms or a linear alkyl group of 1 to 4 carbon atoms;
wherein R₇ is an oxygen or nitrogen atom; and R₈ is a hydrogen atom, CH₃, an aliphatic chain comprising 2 to 5 carbon atoms, or HSO₂CH₃; and
wherein R₉ is H, Cl, I, Br or CF₃; and R₁₀ is a branched aliphatic chain comprising 1-5 carbon atoms.

37. The method of claim 36, wherein said diphenyl ether has a structure represented by formula (I).

38. The method of claim 37, wherein the diphenyl ether is acifluorfen, fomesafen or lactofen.

39. The method of claim 38, wherein the diphenyl ether is lactofen.

40. The method of claim 35, wherein the formulation further comprises one or more adjuvants selected from phytologically acceptable carriers, crop oil concentrates, surfactants, fertilizers, emulsifiers, dispersing agents, foaming activators, foam suppressants, and correctives.

41. The method of claim 40, wherein the adjuvant is a surfactant.

42. The method of claim 41, wherein the adjuvant is a non-ionic surfactant.

43. The method of claim 40, wherein the adjuvant is a crop oil concentrate.

44. The method of claim 40, wherein the adjuvant is ammonium sulfate or urea ammonium nitrate.

45. The method of claim 35, wherein the formulation further comprises one or more other active chemicals.

46. The method of claim 45, wherein the one or more other active chemicals is a herbicide.

47. The method of claim 35, wherein the plant is a legume selected from lima bean, pinto bean or soybean.

48. The method of claim 47, wherein the legume is soybean.

49. A method for increasing the levels of isoflavones in plants, comprising applying to the plant a composition comprising a phytologically acceptable carrier and an effective amount of a diphenyl ether of formula (II): 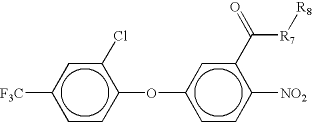
wherein R₇ is an oxygen or nitrogen atom; and R₈ is a hydrogen atom, CH₃, an aliphatic chain comprising 2 to 5 carbon atoms, or HSO₂CH₃.
